(19) United States
(12) Patent Application Publication
(10) Pub. No.: US 2013/0157736 A1
(43) Pub. Date: Jun. 20, 2013

(54) Systems and Methods for Playing and Managing Virtual Activities Via User Devices

(71) Applicant: Sports Challenge Network, LLC, Dacula, GA (US)

(72) Inventors: Colin York Smith, Braselton, GA (US); Thomas Jay Costales, League City, TX (US); Douglas Lloyd Shaffren, Dacula, GA (US); Matthew Thomas Ohlman, Atlanta, GA (US); Tim Minard, Dacula, GA (US)

(73) Assignee: SPORTS CHALLENGE NETWORK, LLC, Dacula, GA (US)

(21) Appl. No.: 13/722,540

(22) Filed: Dec. 20, 2012

Related U.S. Application Data
(60) Provisional application No. 61/577,972, filed on Dec. 20, 2011.

(51) Int. Cl. A63F 13/12; A63F 13/02

(52) U.S. Cl. CPC A63F 13/12; A63F 13/02
USPC 463/7; 463/42

(57) ABSTRACT

Generally, systems and methods for playing and managing electronic games via a mobile device. According to one aspect, users can be located at geographically distributed activity centers (e.g., bowling alleys, golf courses, etc.). Further aspects of the present disclosure generally relate to engaging in challenges with other mobile device users via a mobile software application, wherein the challenges are based on live, in-person activities. Specifically, a user of an embodiment of the present system is able to link scores, statistics, and other information corresponding to an in-person activity (or game) to a virtual environment, thus enabling the user to “play” against another user (often in a separate geographical location) based on the other user's actual, in-person activity.

### CROSS REFERENCE TO RELATED APPLICATION

This application claims benefit under 35 U.S.C. §119(e) of U.S. Provisional Patent Application No. 61/577,972, filed Dec. 20, 2011, and entitled “Systems and Methods For Playing and Managing Electronic Games Via Mobile Devices”, which is incorporated herein by reference as if set forth herein in its entirety.

### TECHNICAL FIELD

The present systems and methods relate generally to computer hardware and software systems in the sports, media, and entertainment industry, and more particularly to systems, apparatuses, and methods associated with playing and managing recreational activities (e.g., sporting events, media events, etc.) for a plurality of geographically distributed users virtually via users' electronic devices.

### BACKGROUND

Persons interested in sports and recreational activities usually derive greater enjoyment by social engagement with other like-minded persons. In many scenarios, persons prefer to play online games or recreational competitions with other persons who also have similar interests via a mobile and/or a web-based electronic platform for purposes of being social, being competitive, and for added excitement.

Traditional online gaming platforms include those that enable users to play fantasy sports such as fantasy football, fantasy baseball, fantasy basketball, etc. The concept of fantasy games has branched out to include non-sports related activities focused on politics, celebrity gossip, movies, and reality TV. Examples of fantasy games in these new categories include fantasy congress, fantasy mogul, and various others. Thus, people located at different geographical locations can play online games or fantasy games or more generally engage in virtual or simulated activities with others.

However, despite the popularity of online gaming, traditional online gaming platforms do not provide the ability to leverage or utilize live, in-person activities or game-play. For example, conventional systems do not allow a bowler at a bowling alley, to use his/her actual scores to compete with other disparately-located bowlers, either in real time or non-real time. Accordingly, existing online recreational systems do not integrate with existing infrastructure at an activity center (e.g., such as a golf course, bowling alley, etc.). Furthermore, traditional online gaming platforms do not enable players located at geographically distributed activity centers to share information (scores, instant messages, etc.), engage in, and play multi-player games (or tournaments) contemporaneously while playing a game. For example, if hypothetical players A and B are in two different bowling alleys located at places X and Y respectively, online gaming platforms of today do not allow such players to play with each other in real time, exchange scores, etc.

Therefore, there is a long-felt but unresolved need for a system or method that can integrate information (e.g., relating to users' recreational activities) from geographically distributed activity centers and manage such information in real time or virtually real time. Such a system would allow a user to be introduced to other users who are interested in playing games and/or tournaments, participate in challenges, exchange information related to recreational activities, and perform various other actions that drive engagement and excitement among users. Additionally, players can redeem points earned by winning tournaments for sports memorabilia, recreational items, or any other items of interest to players. An ideal system (constructed as described herein) is easily customizable by users and system administrators (e.g., employed at sporting centers), provides quick and easy delivery of scores and other information, and can be accessed and operated easily by individuals and users having minimal technical skills.

### BRIEF SUMMARY OF THE DISCLOSURE

Briefly described, and according to one embodiment, aspects of the present disclosure generally relate to systems and methods for playing and managing electronic games via a mobile device. According to one aspect, users can be located at geographically distributed activity centers (e.g., bowling alleys, golf courses, etc.). Further aspects of the present disclosure generally relate to engaging in challenges with other mobile device users via a mobile software application, wherein the challenges are based on live, in-person games. Specifically, a user of an embodiment of the present system is able to link scores, statistics, and other information corresponding to an in-person activity (or game) to a virtual environment, thus enabling the user to “play” against another user (often in a separate geographical location) based on the other user's actual, in-person game play.

To enable aspects of the present system, a scoring interface generally resides at a physical facility. The scoring interface is used to receive and track information relating to the in-person game, and communicate that information to a central server (typically remotely located or virtually located). The central server generally operates a platform application that manages and processes information relating to the in-person games, and further enables the virtual game play amongst various remote, mobile users. The users (players) of the present system generally utilize aspects of the system through a mobile software application operating on a mobile device. Mobile devices generally include smart phones, cellular phones, personal digital assistants (PDAs), tablet computers, laptops, or other such devices. Thus, all system components (scoring interface, central server and platform application, and mobile applications) generally communicate through a wide-area network, such as the Internet.

In one embodiment, the present system includes operative connections to various social media systems (e.g., FACEBOOK™, TWITTER™, FOURSQUARE™, etc.), and enables system users to post game scores, communicate with other game users, and perform other functions through these social media systems. As will be understood and appreciated, aspects of the present disclosure may be utilized in connection with various types of in-person games, including bowling, golf, cross-training, running, fishing, and other events. In essence, any type of activity or game in which players can play singularly and can generate or track specific scores or metrics can be incorporated into aspects of the present system.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment in which an embodiment of the disclosed virtual activity management system (“VAMS”) is utilized.

FIG. 2 illustrates an exemplary system architecture of the VAMS, according to one embodiment of the present disclosure.

FIG. 3 is a flowchart showing high-level, computer-implemented method steps illustrating a data intake and normalization process, exemplarily performed by a VAMS-managed plug PC at an activity center, according to one embodiment of the present system.

FIG. 4 is a flowchart showing high-level, computer-implemented method steps illustrating an alternate data intake and normalization process, exemplarily performed by a VAMS-managed plug PC at an activity center, according to one embodiment of the present system.

FIG. 5 is a flowchart showing an exemplary computer-implemented VAMS server process associated with processing data in connection with users' activity challenges.

FIG. 6 is an exemplary VAMS database schema showing an activity table, in connection with exemplary bowling games played by users, according to one exemplary embodiment of the present system.

FIG. 7 is an exemplary game database logic showing various relational databases, in connection with exemplary bowling games played by users, according to one exemplary embodiment of the present system.

FIG. 8 (consisting of FIG. 8A and FIG. 8B) illustrates screenshots of exemplary VAMS user login interfaces (800A and 800B, respectively), according to one embodiment of the present system.

FIG. 9 (consisting of FIG. 9A, FIG. 9B, and FIG. 9C) illustrates screenshots of exemplary VAMS user interfaces (900A, 900B, and 900C, respectively) associated with challenges, according to one embodiment of the present system.

FIG. 10 (consisting of FIG. 10A, FIG. 10B, and FIG. 10C) illustrates screenshots of exemplary VAMS user interfaces (1000A, 1000B, and 1000C, respectively) associated with challenge- and points-related information, according to one embodiment of the present system.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

### Overview

Aspects of the present disclosure generally relate to systems and methods for playing and managing electronic games via a mobile device. According to one aspect, users can be located at geographically distributed activity centers (e.g., bowling alleys, golf courses, etc.). Further aspects of the present disclosure generally relate to engaging in challenges with other mobile device users via a mobile software application, wherein the challenges are based on live, in-person games. Specifically, a user of an embodiment of the present system is able to link scores, statistics, and other information corresponding to an in-person activity (or game) to a virtual environment, thus enabling the user to “play” against another user (often in a separate geographical location) based on the other user's actual, in-person game play.

To enable aspects of the present system, a scoring interface resides at a physical facility. The scoring interface is used to receive and track information relating to the in-person game, and communicate that information to a central server (typically remotely located or virtually located). The central server generally operates a platform application that manages and processes information relating to the in-person games, and further enables the virtual game play amongst various remote, mobile users. The users (players) of the present system generally utilize aspects of the system through a mobile software application operating on a mobile device. Mobile devices generally include smart phones, cellular phones, personal digital assistants (PDAs), tablet computers, laptops, or other such devices. Thus, all system components (scoring interface, central server and platform application, and mobile applications) generally communicate through a wide-area network, such as the Internet.

In one embodiment, the present system includes operative connections to various social media systems (e.g., FACEBOOK™, TWITTER™, FOURSQUARE™, etc.), and enables system users to post game scores, communicate with other game users, and perform other functions through these social media systems. As will be understood and appreciated, aspects of the present disclosure may be utilized in connection with various types of in-person games, including bowling, golf, cross-training, running, fishing, and other events. In essence, any type of activity or game in which players can play singularly and can generate or track specific scores or metrics can be incorporated into aspects of the present system.

For purposes of illustration and example, the present disclosure describes a specific embodiment of the present system relating to bowling games. Thus, all details and information are provided in connection with bowling systems. As will be understood and appreciated, however, aspects of the present disclosure are not limited to bowling applications, and virtually any type of games (such as golf and the like) may be used.

### Exemplary Embodiment

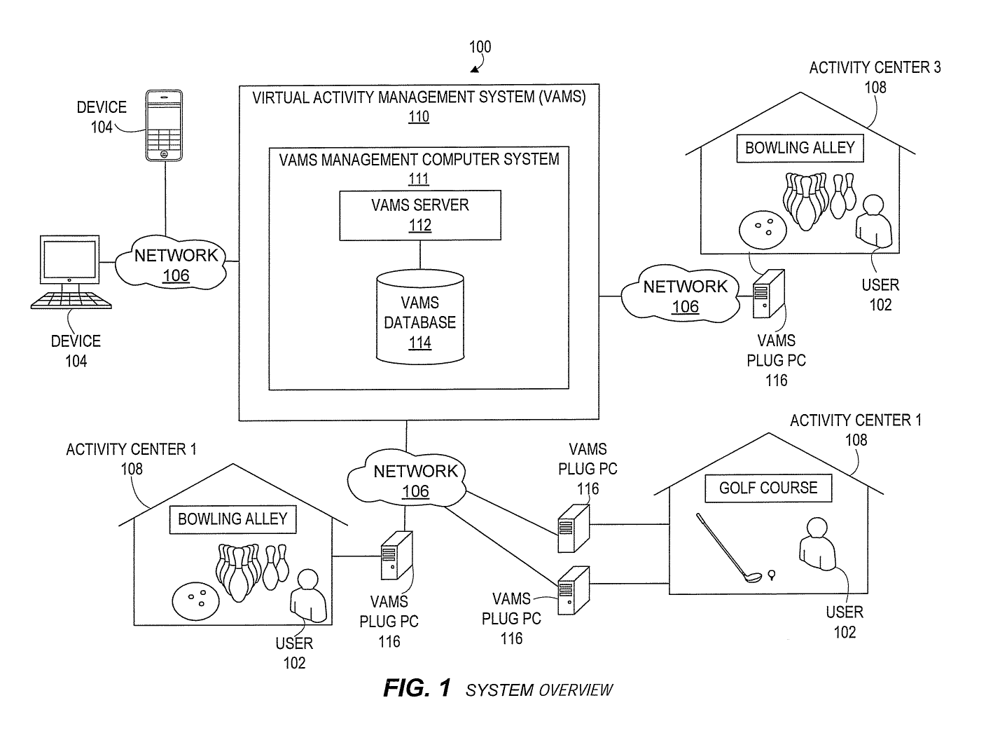

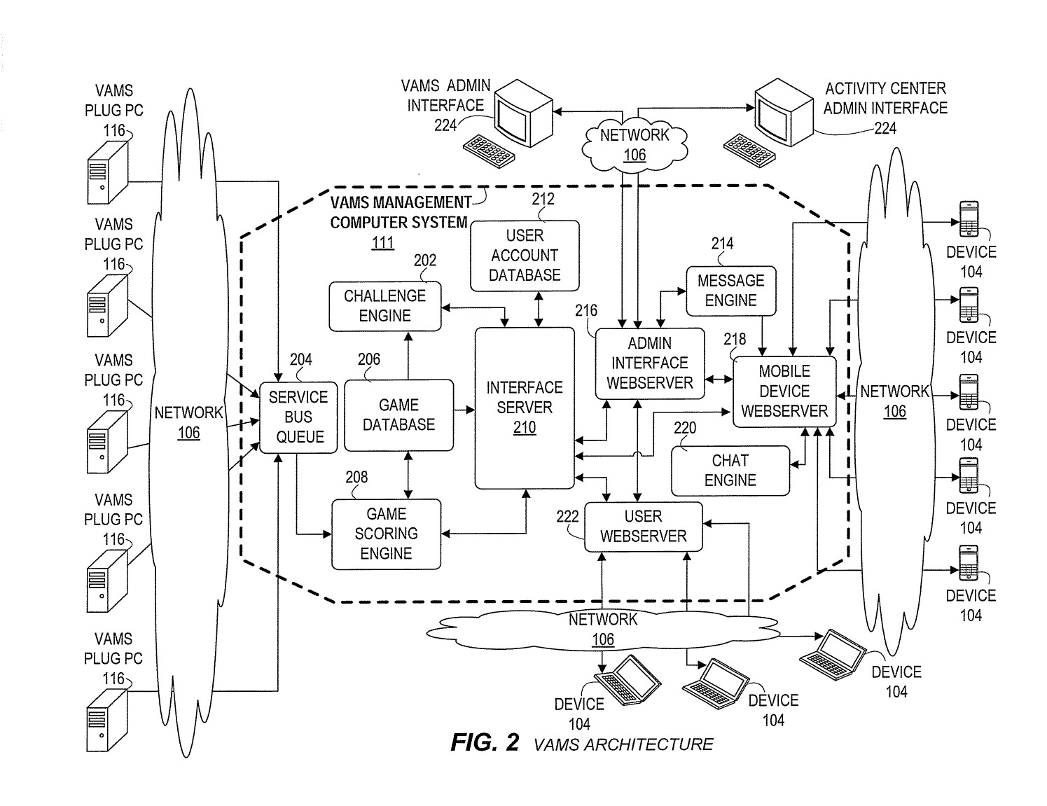

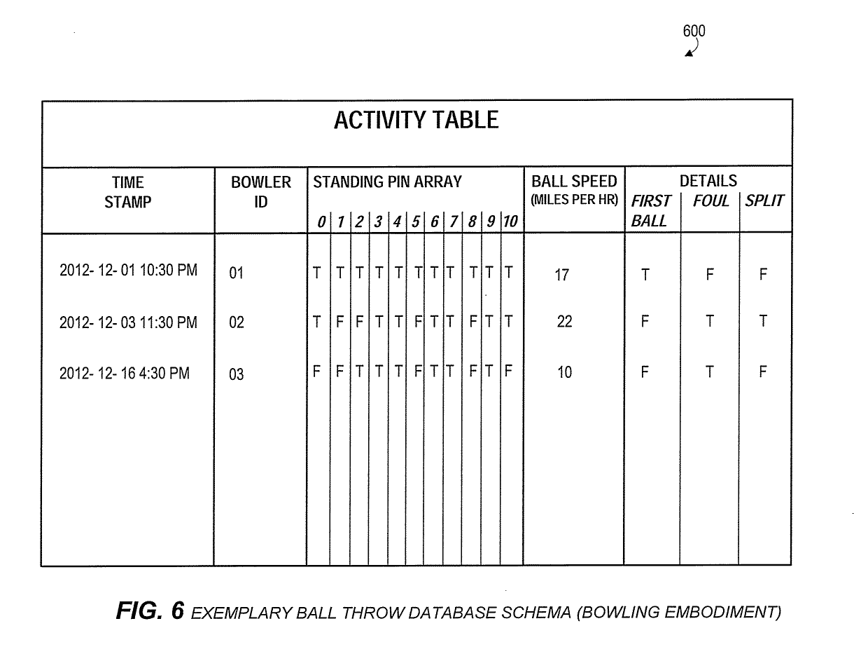

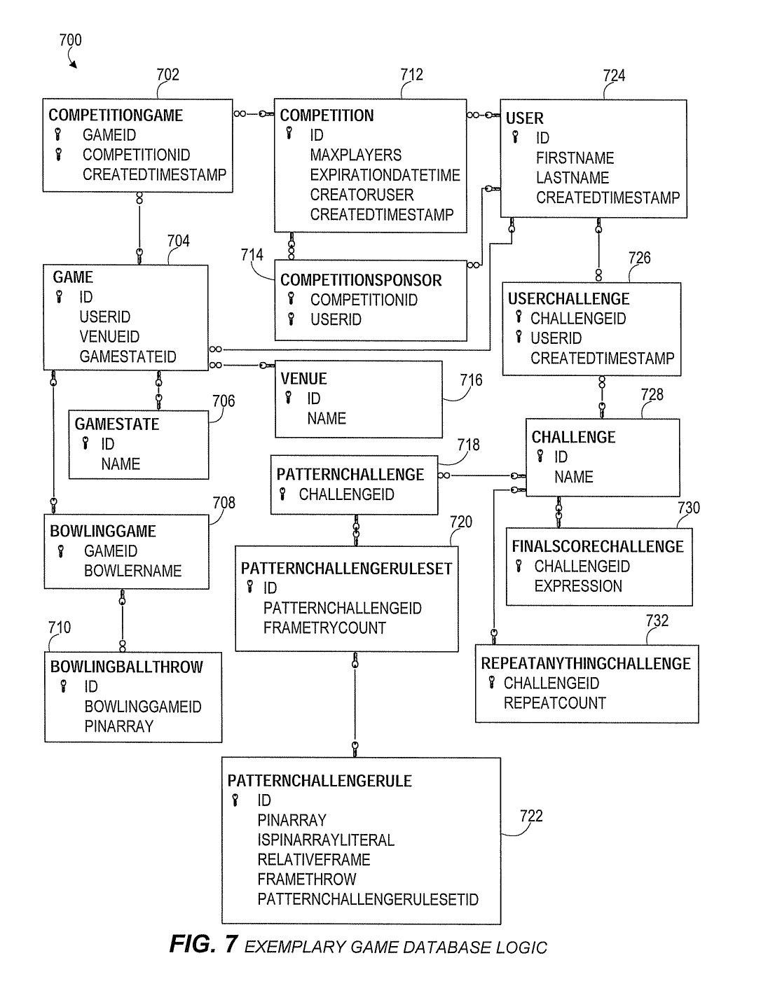

Referring now to the figures, FIG. 1 illustrates an overview 100 of an embodiment of a virtual activity management system (VAMS) 110 in an exemplary environment, constructed and operated in accordance with various aspects of the present disclosure. As shown, the VAMS 110 includes a VAMS Management Computer System 111 for carrying out various computer-implemented processes of the VAMS. Further, the VAMS 110 also includes one or more VAMS databases 114 for storing user data, activity data (e.g., bowling data), and activity center-related data. (Architectural details showing various software modules and engines comprising an embodiment of the VAMS 110 will be described in greater detail in connection with FIG. 2. Exemplary data tables and database logic associated with the VAMS are shown in connection with FIGS. 6 and 7.)

According to one aspect, users 102 engage in various sports and recreational activities (such as bowling, golf, fishing, etc., generally referred to as “activities” herein) at activity centers 108. Users 102 generally compete/play games in person with other players who may or may not be VAMS users. Generally speaking, users involve in activities at geographically distributed activity centers 102 and can earn points (scores) for engaging in activities or tournaments. The VAMS 110 also enables users to compete with each other or against the VAMS for a chance to win rewards and/or points (scores). In one embodiment of the VAMS 110, users can review their personal scores as well as scores of other players. VAMS users can also invite other players to tournaments and challenges. Furthermore, users can redeem points for gift items (e.g., sports memorabilia, gift certificates, coupons, discounts, promotions at activity centers, etc.). Thus, it will be understood that, in one embodiment, the entity that owns and manages the VAMS partners with activity centers (e.g., bowling alleys, golf courses, etc.) and even consumer brands to enable greater engagement for users. In another embodiment, the VAMS 110 provides users with data, analytics, best practices, and recommendations to improve users' performances in connection with activities. For instance, in the context of bowling games, players can engage in various types of challenges, e.g., ball, frame, and game challenges. Challenges can also be individual, league, and team-based. It will be understood that embodiments of the present disclosure are not limited to specific challenges as discussed herein, but have broader applicability and includes user-defined challenges as well.

Usually and as shown in FIG. 1, the VAMS 110 includes operative connections to a plurality of activity centers 108, users 102 (via devices 104), and other systems (not shown herein) via one or more networks 106, such as the Internet. According to an aspect, the operative connections involve a secure connection or communications protocol, such as the Secure Sockets Layer protocol. Furthermore, it will be understood by one skilled in the art that communication over networks 106 typically involves the usage of one or more services, e.g., a Web-deployed service with client/service architecture, a corporate Local Area Network (LAN) or Wide Area Network (WAN), or through a cloud-based system. Moreover, as will be understood and appreciated, various networking components like routers, switches, hubs etc., are typically involved in the communications. Although not shown in FIG. 1, it can also be further understood that such communications may include one or more secure networks, gateways/firewalls that provide information security from unwarranted intrusions and cyber attacks.

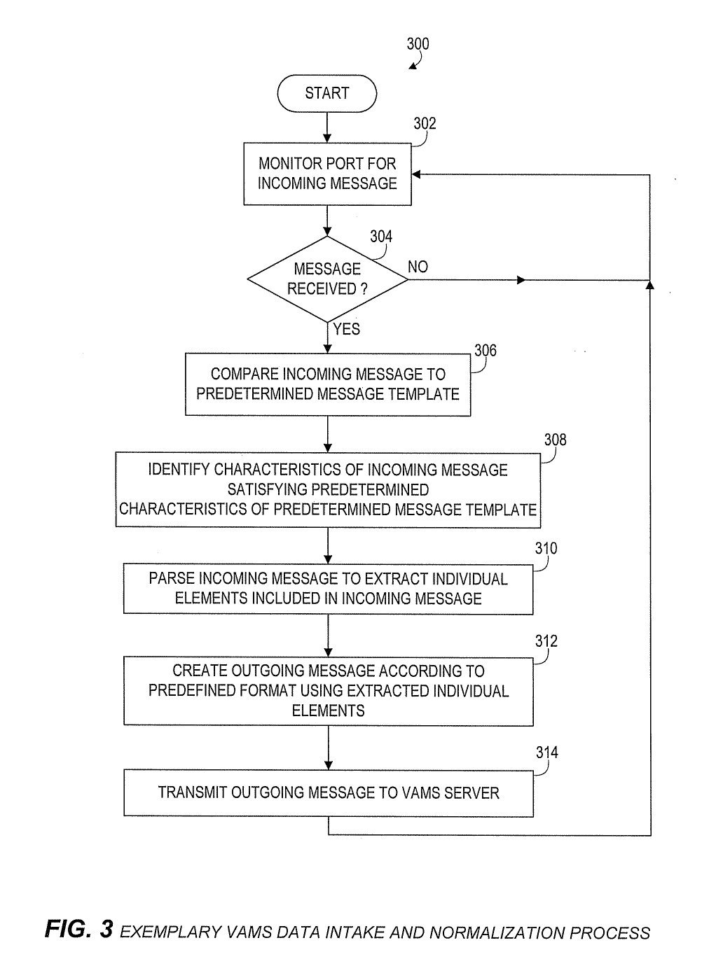

According to the embodiment shown in FIG. 1, the VAMS 110 is operatively connected to one or more system users 102 and one or more activity centers 108 (e.g., bowling alleys, golf courses, etc.) at different geographical locations. According to one aspect, users 102 engage in various activities (generally in-person physical activities) at activity centers 108. Further, in the embodiment shown in FIG. 1, the VAMS 110 (or system administrators affiliated with the VAMS 110) administers one or more VAMS mini-servers, edge servers, or plug PCs 116 at the activity centers 108. In an exemplary embodiment, plug PCs communicate users' activity-related information to the VAMS servers 112. For example, the entity that owns and/or manages the VAMS 110 maintains a VAMS server 112 that is operatively connected to VAMS plug PCs 116. Thus, the VAMS plug PCs 116 might have a software program (e.g., a dedicated program) that connects with the VAMS servers (that host a suite of sophisticated software applications as explained later) 112 via a network 106 to communicate information relating to tournaments and games/challenges played by users 102 at the activity centers 108. (Exemplary computer-implemented process steps performed by VAMS servers 112 and VAMS plug PCs 116 will be discussed in detail in connection with FIGS. 3-5.) The plug PCs 116 in other embodiments, can be maintained by personnel and/or system administrators working at activity centers 108. VAMS plug PC-based communications can generally involve a combination of broadcast technologies such as cellular and Wi-fi.

In one embodiment, when a user is engaged in an activity at an activity center 108 (e.g., a bowling alley as shown in FIG. 1), various actions performed by a user are communicated to VAMS servers 112 via the plug PCs 116, generally in connection with a legacy computer system at the activity center. In another embodiment, such actions are communicated in a series of successive steps. For instance, in a bowling alley, information relating to a user's ball throws are first recorded by a computer system at the bowling alley. Then, in the second step, such information is communicated to VAMS plug PCs 116 by the legacy computer system at the activity center. Subsequently, the VAMS plug PCs communicate that information to (typically remotely located) VAMS servers 112 via networks 106.

Generally, other users who wish to play with the user can play virtually with the above-mentioned user. Users can search for other users via the VAMS 110 who are playing a game or engaging in an activity contemporaneously or who already competed in a game and saved his/her respective score. For example, if hypothetical players A and 3 are in two different bowling alleys located at places X and Y respectively, then the VAMS enables such users to play with each other virtually (based on the actual, in-person activity of each player). It will be understood that \TAMS embodiments are not limited to just two players; any number of players involved in any type of activity can engage/play virtually via the VAMS 110. Thus, the VAMS 110 allows users to participate in tournaments/challenges, exchange scores and activity information, create challenges, exchange instant messages, or take any other pertinent activity-related action. Users 102 can use various types of electronic devices to review activity-related information either while at the activity center in the middle of a game, or even at other times when the user desires to review such information.

As will be understood, various types of electronic devices 104 can be used by users 102 to access the VAMS 110, and there is no limitation imposed on the number of devices, device types, brands, vendors and manufacturers that may be used. For example, a user can access his or her VAMS account via multiple devices. Example of devices 104 include computers (e.g., laptops, desktops, tablet computers, etc.) or mobile computing devices (e.g., smart phones) or even dedicated electronic devices capable of accessing the Internet. Because of the nature of these devices, the network communications between them will typically be accomplished wirelessly.

Generally speaking, and as will be understood by a person skilled in the art, the VAMS user interface comprises a webpage (e.g., front-end of an online gaming portal) managed by the VAMS 110, accessible through a software program such as a web browser by users. Examples of commonly-used web browsers include but are not limited to, Microsoft's Internet™ Explorer™, Mozilla™ Firefox™, Apple™ Safari™, Google™ Chrome™, and others. According to another aspect, an embodiment of the VAMS (including the VAMS user interface) is hosted on a physical server, or alternately in a virtual “cloud” server.

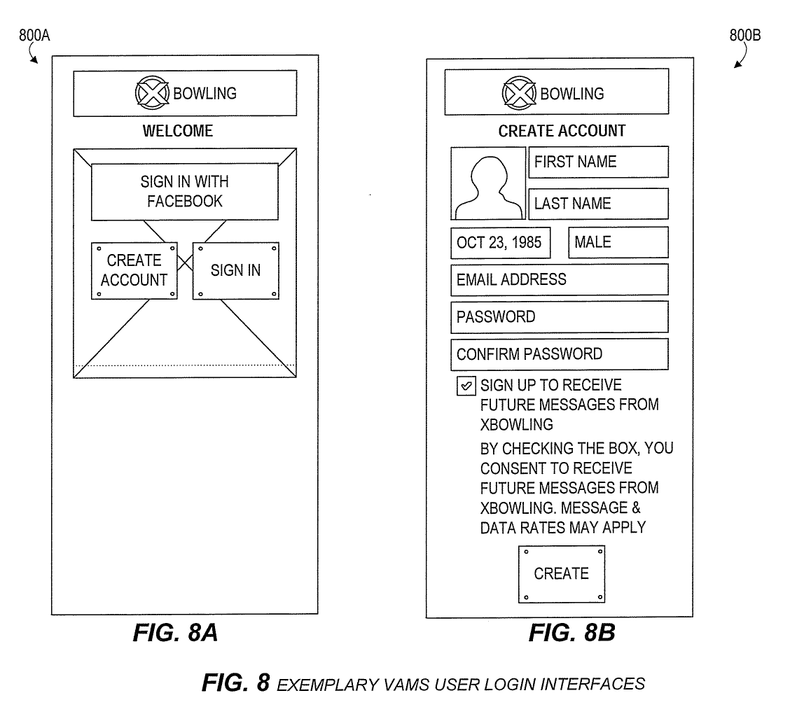

According to an exemplary embodiment of the present disclosure, the VAMS user interface can also be configured as a VAMS-managed mobile device application (app) such as that applicable for the popular APPLE™ IPHONE™ and GOOGLE™ ANDROID™ mobile device operating systems, for allowing users to access their VAMS accounts, specify/request their preferences for certain types of games, create new user-created games along with associated rules, invite/challenge other users, accept invitations/challenges from other players, engage in instant messaging with other players, and perform various other activities as will occur to one skilled in the art. According to another embodiment, the VAMS user interface configured as a mobile device application can co-exist jointly with the VAMS user interface accessible through a web browser. Exemplary VAMS user interfaces for various functionalities are shown herein in connection with FIGS. 8-10.

For purposes of example and explanation, it can be assumed that end users 102 (customers) initially register with an embodiment of the VAMS 110. The registration (usually a one-time activity) can be accomplished in a conventional manner via a VAMS user interface, or via a mobile device application program that communicates with the VAMS 110. During registration, a user 102 may provide relevant information, such as the user's name, address, email address, credit/debit card number for billing purposes, personal preferences relating to certain types of activities/games and other similar types of information. Typically, as will be understood, information provided by system users during registration is stored in an exemplary VAMS database 114.

The discussions above in association with FIG. 1 merely provide an overview of an embodiment of the present system for playing and managing electronic games via a mobile device. Further aspects of the present disclosure generally relate to engaging in challenges with other mobile device users via a mobile software application, wherein the challenges are based on live, in-person activities. Accordingly, it will be understood that the descriptions in this disclosure are not intended to limit in any way the scope of the present disclosure. For example, in various embodiments, marketing campaigns and targeted advertisements can be delivered to users via the VAMS-managed mobile app. Further, the entity that owns and manages the VAMS 110 can use the disclosed VAMS platform for business/brand promotional opportunities and marketing. Alternately, VAMS-managed apps can be integrated with location-based technologies (such as GPS and the like) to allow various location-based functionalities (geographic check-ins at a location, enabling notifications to be sent to users' mobile devices, etc.). Also, in alternate VAMS embodiments, plug PCs may not be employed at the activity centers. In such embodiments, computer systems at the activity centers can directly communicate users' activity-related information to the VAMS servers. Various architectural details of an embodiment of the disclosed VAMS will be described next in greater detail.

FIG. 2 illustrates an exemplary system architecture 200 of the VAMS Management Computer System 111. It will be recalled from the earlier discussions that the VAMS Management Computer System 111 is included in the disclosed VAMS 110. According to one embodiment of the present system, the overall VAMS is made up of several software modules (also alternatively referred to herein as VAMS servers 112) that provide specific services and are connected to each other with pre-defined interfaces, that allow for parallel development of the various modules. Typically, in VAMS embodiments, modules are divided into three different categories: webservers, engines, and databases. Generally, webservers act as interfaces with the outside world (e.g., to VAMS plug PCs 116 and/or devices 104 operated by users 102). Engines perform tasks and manipulate data, which is stored in one or more VAMS databases.

According to one embodiment of the present disclosure, the VAMS webservers include an interface server 210, an admin interface webserver 216, a mobile device webserver 218, and a user webserver 222. The VAMS engines generally include a challenge engine 202, a game scoring engine 208, a message engine 214, and a chat engine 220. Exemplary VAMS databases 114 include user account database 212 and game database 206. Such databases are collectively referred to herein as VAMS database 114 (e.g., refer to FIG. 1).

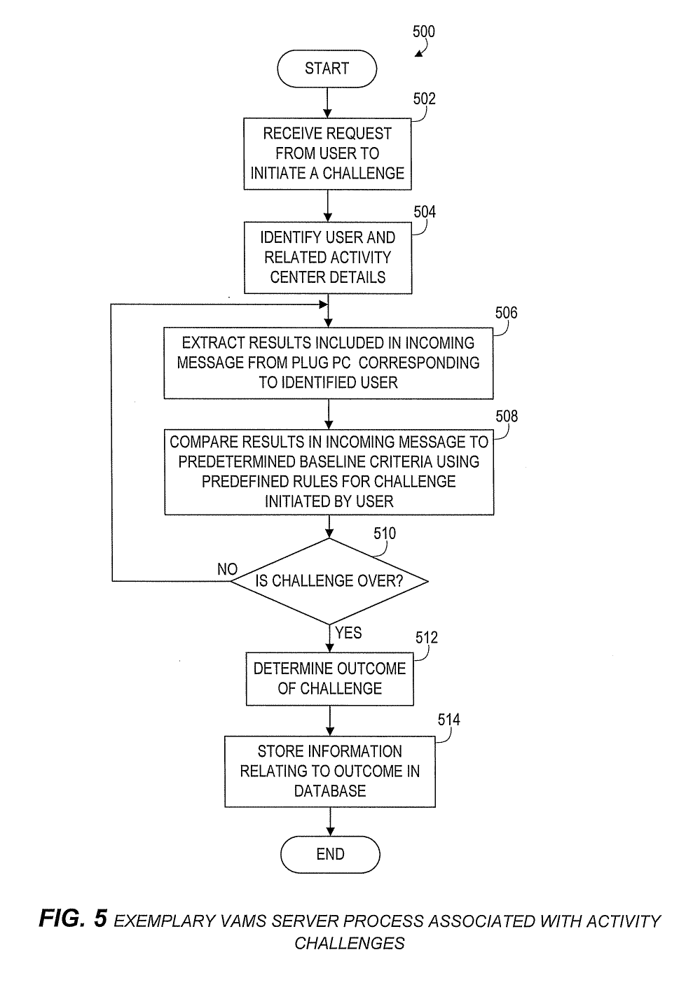

According to another embodiment of the present disclosure, the admin interface webserver 216 enables a system administrator (affiliated with the VAMS or activity centers) to control every aspect of the functionality of the system. It is referred to as a webserver because the user interface is accessed generally through the Internet, but it generally includes functionalities beyond a typical webserver. The admin interface webserver 216 usually interfaces with the game scoring engine 208 to provide access to activity center data and VAMS usage. It also communicates with the user account database 212 to provide information relating to VAMS users, including their contact information, billing account information, and usage statistics, among other things. Additionally, the admin interface webserver 216 also manages various challenges being offered and run by the challenge engine 202, setting and maintaining the rules for each challenge, determining whether or not a particular game has been enabled or disabled at any particular point in time, and other such functions. (An exemplary VAMS server process associated with a challenge is discussed in connection with FIG. 5.) The challenge engine 202 is typically involved in actually monitoring live scoring data and administering a game while it is being played by users at geographically distributed activity centers. In an exemplary embodiment, the admin interface webserver 216 controls the functionality of the mobile device webserver 218 and the consumer webserver 222. According to an exemplary embodiment, the interface server 210 controls the access to and from the various VAMS databases 114.

The interface server 210 is generally the primary interface to user devices 104. It controls how and what is being displayed on the devices, as well as relays instructions and other inputs from the devices to the other modules within the system. Since devices 104 usually run a light-weight application program, the mobile device webserver 218 is able to change the look and feel of the user interface displayed on the device. Such a feature makes it possible to adapt to future programs, sponsors, and challenges. The user webserver 222 provides challenge offerings, sponsorships, real time scoring screens, and other such features. Like the mobile device webserver, the user webserver 222 interfaces with devices 104 via standard HTML protocols; however, because it is typically optimized for laptops and PCs, it can offer additional the dynamic content made possible through Java and Flash applications, among others.

In one embodiment of the VAMS, the game scoring engine 208 is the central scoring engine, and drives the displays on devices 104. Thus, when any of the other modules need information about the scoring of a specific game or activity, this information is relayed through an IP connection to that software module. In an exemplary embodiment, the game scoring engine 208 accesses the service bus queue 204 to read the pertinent data fields and pass scoring results to the game database 206 for use as needed. The VAMS-managed plug PCs, in one embodiment, communicate with the VAMS via the service bus queue 204.

The challenge engine 202 is the central scoring engine for computing the results of all challenges being conducted by a user. Generally speaking, a challenge (as referred to herein) comprises a virtual activity that relates to a physical activity. Such physical activities, usually performed by users at disparate geographical locations, possibly at activity centers. In the context of bowling, an example of a challenge can be a head to head bowling game involving two or more users. A challenge can also be based on playing a certain number of frames. Another example of a challenge is “which user gets the first strike”. It will occur to one skilled in the art that challenges can be of any type, involve any number of users, and can be defined by users as well. The challenge engine 202 receives challenge scoring instructions from the admin interface webserver 216, and uses scoring results obtained from the game database 206 to determine the outcome of a challenge which has been entered by the user. Those results are then relayed to the user via the interface server 210, thereby providing consistent results across multiple platforms and without requiring redundant calculations to determine results.

The message engine 214 is usually controlled by the admin interface webserver 216, and communicates instant messages through the mobile device webserver. The user account database 212 is generally considered the repository of all information associated with users. Contact and billing information (in connection with purchase of loyalty points for activity centers), along with user statistics and preferences, are stored in the user account database 212.

According to one embodiment of the present VAMS 110, the game database 206 provides live scoring results to other modules of the VAMS. In an exemplary embodiment, the game scoring engine 208 has write access to the game database 206. Also, in another exemplary embodiment, the game scoring engine 208 and the interface server 210 have direct read access to the game database 206. All other components requiring access to the game database 206 make requests via the interface server 210 using standard API protocols.

As will be understood by one skilled in the art, various other modules and components (different from the ones described in FIG. 2) can comprise the VAMS management computer system 111 in alternate embodiments. The presently-shown embodiment is for exemplary purposes only and not intended to limit the functionality of the VAMS architecture. In what follows next, a high-level overview of an exemplary VAMS process will be described.

FIG. 3 illustrates an exemplary data intake and normalization process 300 that is performed by various modules and software components associated with an embodiment of the virtual activity management system 110 for playing and managing electronic games via a mobile. In one embodiment, the VAMS process 300 is executed on one or more VAMS plug PCs 116 installed at activity centers 108 (e.g., bowling alleys, golf courses, etc.). According to one embodiment, the plug PCs are small form factor servers that consume less power as compared to traditional PCs or servers. An example of such a plug PC is the MIRABOX™ device manufactured by Globalscale Technologies, Anaheim, Calif.

Generally the VAMS plug PCs 116 are operatively connected to VAMS servers 112 and computer systems owned and operated by activity centers, e.g., in connection with bowling activity centers such as BRUNSWICK™, AMF™, CUBICA™, and others. In one embodiment, the plug PCs usually run a version of the LINUX operating system, running JAVA programs, and are equipped with one or more network interface cards. One network interface card is connected to the computer system owned and operated by the activity center wherein the plug PC is installed. Another network interface card is connected to networks 106 such as the Internet.

Starting at step 302, the process 300 associated with a VAMS plug PC 116 monitors a network port for incoming messages. In one embodiment, a message comprises a data packet sent over one or more data networks involving network protocols such as TCP/IP or UDP. For example, in the context of a bowling game) a message might include details such as a bowler's lane number, a bowler's position with respect to other bowlers, a ball number, a standing pin count, etc. Messages are usually sent by the computer system of the activity center to a VAMS plug PC. No limitations are imposed on the data type, format, or content of VAMS messages.

At step 304, the VAMS plug PC determines whether or not a message is received. If the VAMS plug PC determines that a message is not received, then the process loops back to step 302. Assuming VAMS users engage in activities or play games/tournaments/challenges, etc. at activity centers, the VAMS plug PC receives a message that includes information relating to each user's activity. Thus, if the process determines that a message is received, then the process compares (at step 306) this incoming message with a predetermined message template. In the context wherein an activity is a bowling game, such message templates can correspond to ball throw events, instructions to pin setter mechanisms, opening/closing of bowling lanes, etc. Various other message templates may exist as will occur to one skilled in the art.

At step 308, the plug PC parses the incoming message to extract individual data elements included in the incoming message. (In one exemplary embodiment, such messages are in HTML, JSON, or XML formats.) Such data elements are preformatted to exist at specific places (e.g., bit positions) within an incoming message that is usually of a predetermined length (e.g., 100 bytes). Examples of such elements in the context of bowling can include (but are not limited to) a lane number, a bowler's position with respect to other bowlers, a ball number, a standing pin count, a frame number, a total score, a ball speed, an indication of whether a bowling attempt corresponds to a foul or not, and various other data elements. Exemplary data elements will be discussed in connection with FIGS. 6 and 7.

Then, at step 312, an outgoing message is created according to a predetermined format using the individual data elements that were extracted (in step 310). Eventually, this outgoing message is communicated to a VAMS server 112. It will occur to one skilled in the art that VAMS plug PC embodiments are essentially involved in an underlying data normalization process associated with converting a preformatted incoming message (having inherent characteristics) into another outgoing message having a (same or) different predetermined format. Thus, the normalization process involves creating a mapping between information provided by computer systems at activity centers (included in incoming messages) and outgoing messages transmitted by the VAMS plug PCs to VAMS servers. This enables the VAMS plug PCs to be compatible with a plurality of different activity centers involving a variety of activities, but without requiring changes in the infrastructure (e.g., IT and computer systems) at the activity centers.

Although not shown in FIG. 3, it will be understood that in many VAMS plug PC embodiments, a JAVA program (comprising a series of modules developed and coded by VAMS software personnel) is executed in combination with a properties file. Such a properties file (e.g., similar to a read-me file) specifies which specific modules will be used. Each module is configured to correspond to a specific activity center. However, a plurality of different modules (for different activity centers) loaded on a VAMS plug PC allows the same VAMS plug PC to be operational in different activity centers. Furthermore, the properties file (mentioned above) also includes a URL corresponding to a network address of the VAMS server, and a unique activity center ID (and possibly a network address) of the respective activity center wherein the VAMS plug PC is installed.

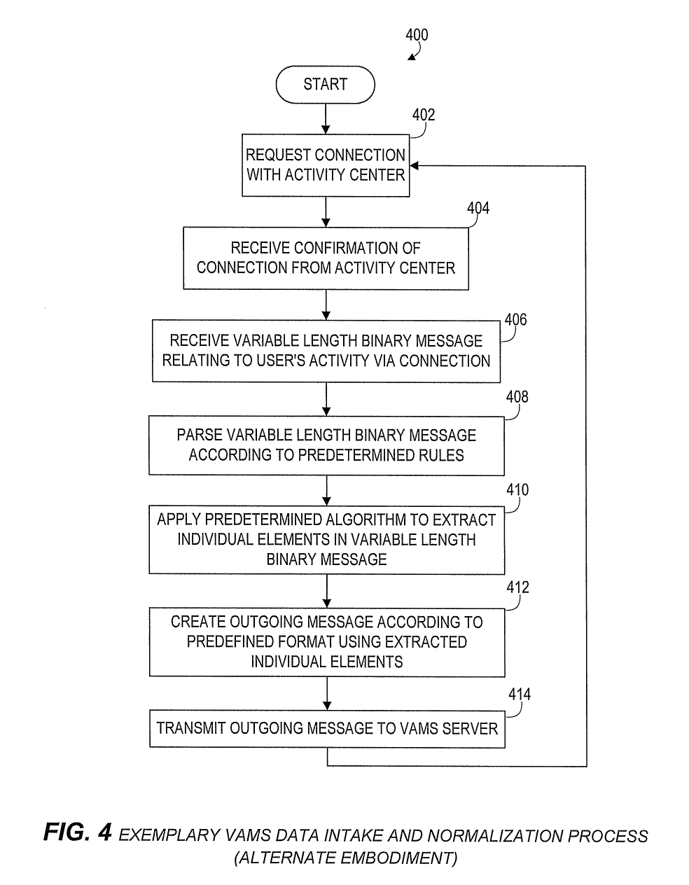

Now referring to FIG. 4, an alternate embodiment of a VAMS plug PC data intake and normalization process 400 is described. In many scenarios, the computer systems at the activity centers may not be able to encode messages in a high-level markup language such as XML. Therefore, in such scenarios, the incoming messages (arriving at the plug PCs) are usually encoded in variable-length binary formats. Also, in such scenarios, the computer system at the activity center might not be advanced enough to transmit messages to a VAMS plug PC and therefore, the VAMS plug PCs typically have to requests for messages (via a TCP?IP connection) with a computer system at an activity center instead of monitoring their respective network ports for incoming messages.

Starting at step 402, the VAMS plug PC requests a connection with a computer system at an activity center. Typically, the computer system at an activity center accepts a connection request, which is received by the VAMS plug PC at step 404. Assuming VAMS users engage in activities (e.g., play games, challenges, tournaments, etc.) at activity centers, accordingly, at step 406, the VAMS plug PC receives a variable-length binary message from the computer system at the activity center relating to a user's activity via the established connection.

At step 408, the VAMS plug PC parses the incoming message to extract individual data elements included in the incoming message. In many embodiments, the VAMS plug PC applies predetermined algorithms to extract the individual data elements in the message. In one exemplary scenario, the incoming message increases in size incrementally with updated information as the user continues to engage in an activity. In such scenarios, the predetermined algorithm compares a current variable-length binary message to a previous variable-length binary message to determine the increment information corresponding to the most recent action such as an updated score or updated ball throw information. Then, at step 414, an outgoing message is created according to a predetermined format using the individual data elements that were extracted (in step 408). Eventually, this outgoing message is communicated to VAMS server 112. In what follows next, an embodiment of a VAMS server process will be described in greater detail.

FIG. 5 illustrates an exemplary VAMS server process 500 associated with activity challenges played by VAMS users generally at geographically distributed activity centers 108. In the context of bowling, an example of a challenge can be a head to head bowling game involving two or more users. A challenge can also be based on playing a certain number of frames. Another example of a challenge is “which user gets the first strike”. It will occur to one skilled in the art that challenges can be of any type, involve any number of users, and can be defined by users as well.

Starting at step 502, a VAMS server receives a request from a VAMS user to initiate a challenge, typically via an app or a program running on the user's device, and usually while the user is engaged in an activity at an activity center. It will be understood that requests can be initiated by any number of users, at any geographical location, and involving any type of user device. Further, challenges can be initiated when a user is located at an activity center before, or perhaps even after the physical activity associated with the challenge, regardless of whether the physical activity is in happening in real time or not.

At next step 504, the VAMS server identifies (from the user's request) the requesting user, and related activity center details. It will be understood that the request from the user (in step 502) typically includes information identifying a user and an activity center. Exemplary details include a user ID, an activity center ID, a time stamp, and other details. It will occur to one skilled in the art that the request can also include a geographical location of the activity center, e.g., as obtained by a location-based technologies (such as GPS and the like). It will be assumed that at the respective activity center, a user initiates a challenge (although no such limitation is imposed in alternate embodiments). Intermediate results associated with an activity challenge (usually provided by computer systems at activity centers) are received (at step 506) in the form of an incoming message at the VAMS server during a challenge initiated by a user.

Then, at step 508, the VAMS 110 compares the results included in the incoming message with predetermined baseline criteria associated with one or more predefined rules for the challenge initiated by the user. For instance, in a challenge pertaining to a frame-based challenge, the baseline criteria comprises identifying a user who wins a maximum number of frames. It will occur to one skilled in the art that in alternate VAMS embodiments, various types of baseline criteria can be involved depending on challenges, users, and the associated activities. Next, at step 510, the process 500 determines whether or not the challenge initiated by the user is over. If the process 500 determines that the challenge is not over, the process loops back to step 506. Various criteria can be involved in determining that a game is over. Such criteria can be time-based or activity-based, as will occur to one skilled in the art. However, if the VAMS determines that the challenge is over, then the process moves to step 512 wherein the process determines the outcome of the challenge. Generally, the outcome of a challenge is also associated with a win/loss, details of scores, and other challenge-related attributes. Such attributes (generally, information) are stored in a database at step 514.

Turning to FIG. 6, an exemplary activity table 600 in connection with an exemplary activity, i.e. ball throws in a bowling game is shown, according to one embodiment of the present system. As shown in FIG. 6, the bowling ball database comprises the following exemplary columns: time stamp, bowler ID, standing pin array, ball speed, and details. The details column further comprises the following columns: first ball, foul, and split. For example, at 10:30 PM on Dec. 1, 2012 a bowler with BowlerID 01 bowled at a speed of 17 miles per hour and was able to strike all ten pins (numbered 0 through 10) in the standing pin array column. According to one exemplary aspect, a bowling pin that has been knocked down by a bowler is denoted with a F (false). Thus, a pin that has not been knocked down is indicated with a T (true). The activity table also indicates that this was a first ball for the bowler with bowling ID 01, and that this was neither a foul nor a split.

Furthermore, as will be understood by one of ordinary skill in the art, data tables and database logic shown herein are presented for illustrative purposes only, and embodiments of the present system are not limited to data, information, and fields in the specific data tables shown. Additionally, the VAMS, in alternate embodiments can comprise various other data tables (and databases), as will occur to one skilled in the art.

Referring to FIG. 7, an exemplary game database logic 700 is shown, according to one embodiment of the present VAMS. In one embodiment (as shown), the game database logic 700 is constructed as a relational database comprising several data tables that are inter-accessible. In an exemplary bowling context, examples of such data tables include (but are not limited to) a competition game data table 702, a game data table 704, a game state data table 706, a bowling game data table 708, a bowling ball throw data table 710, a competition data table 712, a competition sponsor data table 712, a venue data table 716, a pattern challenge data table 718, a pattern challenge rule set data table 720, a pattern challenge rule data table 722, a user data table 724, a user challenge data table 726, a challenge data table 728, a final score challenge data table 730, and a repeat anything challenge data table 732. Exemplary columns or data fields associated with these above-mentioned data tables are also shown in FIG. 7. It is assumed that the workings and usage of these data tables and data fields will occur to one skilled in the art and accordingly are not provided herein. In what follows next, exemplary screenshots displaying various features and functionalities of the VAMS are provided next.

FIG. 8 (consisting of FIG. 8A and FIG. 8B) illustrates exemplary screenshots 800A and 800B of a VAMS user-login interface, as viewed on a user's device 104. According to one embodiment of the disclosed VAMS, a user can login into his or her VAMS accounts by a username/password combination created by the user when registering with the VAMS for the first time. Exemplary screenshot 800B illustrates various data fields (name, email, date of birth, etc.) that are typically provided by users during the one-time registration process. In another exemplary embodiment, users can utilize their username/password on a social media system such as FACEBOOK™ to login into their VAMS account. It will occur to one skilled in the art that various social media systems provide plug-in software to external applications and websites that enable users to login into an external application (such as that managed by VAMS) using their social media system username/password. Also, in many VAMS embodiments, users can share details (e.g., scores, wins/losses, experiences, etc.) relating to his or her VAMS-associated activity on social media systems. Thus, in such scenarios, the VAMS includes plug-in software associated with the respective social media systems to enable users to share details relating to their activities.

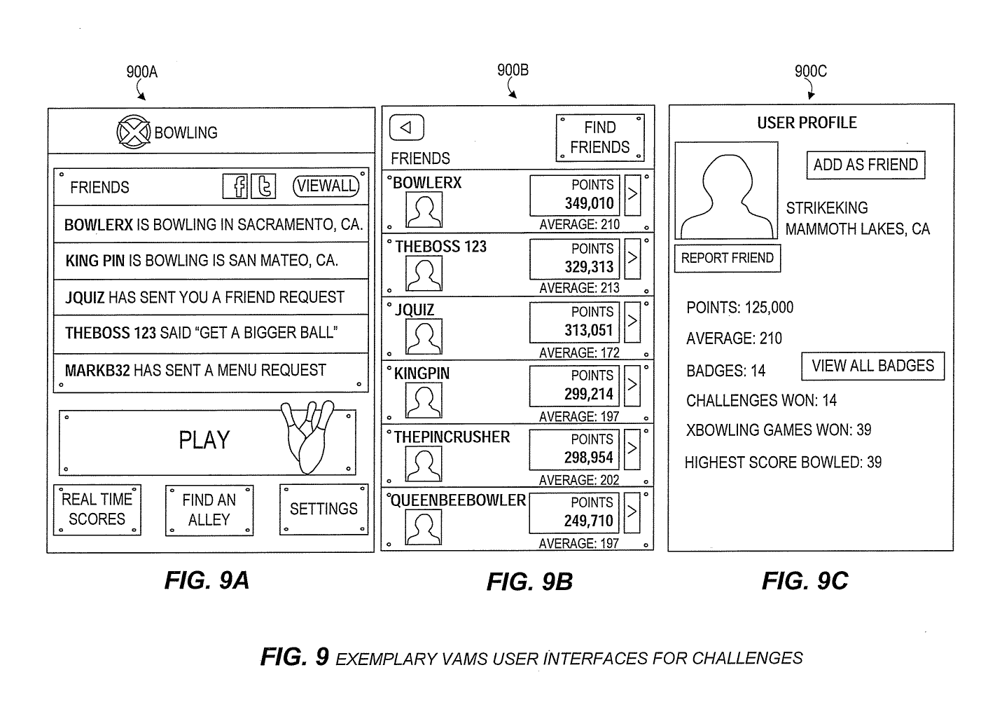

Turning to FIG. 9, exemplary screenshots 900A, 900B, and 900C are shown relating to activity challenges and social media interactions. For example, in FIG. 9A, various real-time updates from a user's friends (possibly VAMS users) are shown. For example, a user's friend called “Bowlerx” is bowling in Sacramento, Calif. Another user called “King Pin” is bowling in San Mateo, Calif. Screenshot 900A also displays exemplary options to a user. Such options include displaying real time scores, finding a bowling alley, changing the user preferences or settings in connection with the user's VAMS account via the interface, etc. In FIG. 9B, exemplary scores of other VAMS users in connection with total points are accumulated. In one embodiment, a user's average score in connection with challenges is also displayed. In one embodiment of the disclosed VAMS, users can also search (via the VAMS user interface) for his or her friends (e.g., other VAMS users) to play challenges. In other embodiments, users can search for unknown users based on profile information, like handicapped users, average score of users, etc. For example, in FIG. 9C (screenshot 900C), a profile of a VAMS user called “Strikeking” is in Mammoth Lakes, Calif. is shown. The user has accumulated a total of 125,000 points, has an average score of 210, and has won 14 badges and 14 challenges. Various other details of the user are also displayed on the interface.

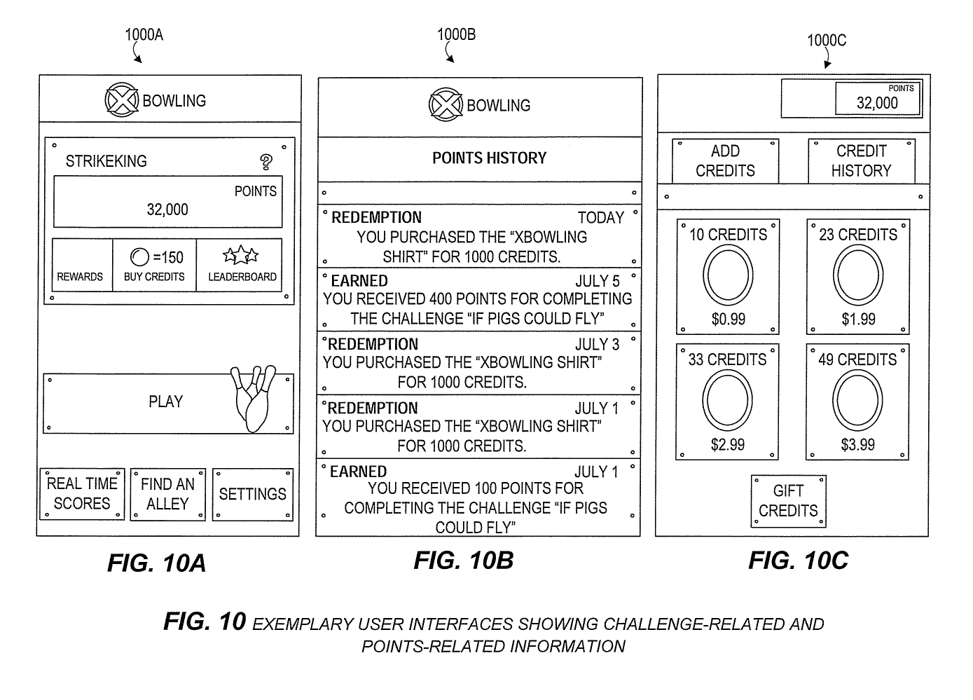

Referring to FIGS. 10A, 10B, and 10C, exemplary screenshots 1000A, 1000B, and 1000C are shown displaying points- and challenge-related information. In one embodiment of the disclosed VAMS, a user earns rewards points (exemplarily described later herein) based on his or her performance in challenges relating to in-person activities at activity centers. A user can also click on a “Leaderboard” icon on the interface that displays the rankings of users currently leading a challenge. Users can generally initiate a challenge by clicking on the “Play” icon. In another embodiment of the disclosed VAMS, users can redeem, buy, and/or share rewards points with other users. (FIG. 10C demonstrates that users can buy points or redeem points for a monetary value or can gift points to other users.)

Also, as shown in FIG. 10B, users can redeem credits or points for merchandise, sometimes provided by the activity centers 108, sometimes provided by the VAMS 110, and sometimes provided by a third party entity. In FIG. 10B, the interface displays that a user purchase a shirt for 1000 credits and earned 400 points for competing in a challenge. Thus, it will appear to one skilled in the art that according to embodiments of the disclosed VAMS, users can earn points via various other ways besides just winning tournaments and challenges.

The exemplary screenshots in connection with FIGS. 8-10 are for illustrative purposes only. Various aspects of the VAMS 112 exist that have not been shown in the screenshots. Further, there can be alternate ways in which the interface can be designed with different buttons, menu bars, tabs and other interface features. Also, in various embodiments, marketing campaigns and targeted advertisements can be delivered to users via VAMS-managed mobile apps running on user devices.

Aspects of the present disclosure generally relate to systems and methods for playing and managing electronic games via a mobile device. According to one aspect, users can be located at geographically distributed activity centers (e.g., bowling alleys, golf courses, etc.). Further aspects of the present disclosure generally relate to engaging in challenges with other mobile device users via a mobile software application, wherein the challenges are based on live, in-person games. Specifically, a user of an embodiment of the present system is able to link scores, statistics, and other information corresponding to an in-person activity (or game) to a virtual environment, thus enabling the user to “play” against another user (often in a separate geographical location) based on the other user's actual, in-person game play.

To enable aspects of the present system, a scoring interface resides at a physical facility. The scoring interface is used to receive and track information relating to the in-person game, and communicate that information to a central server (typically remotely located or virtually located). The central server generally operates a platform application that manages and processes information relating to the in-person games, and further enables the virtual game play amongst various remote, mobile users. The users (players) of the present system generally utilize aspects of the system through a mobile software application operating on a mobile device. Mobile devices generally include smart phones, cellular phones, personal digital assistants (PDAs), tablet computers, laptops, or other such devices. Thus, all system components (scoring interface, central server and platform application, and mobile applications) generally communicate through a wide-area network, such as the Internet.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

What is claimed is:

1. In a virtual activity management computer system (VAMS), wherein the VAMS includes a VAMS management server wirelessly connected to one or more edge servers located at one or more corresponding activity centers, and wherein the one or more edge servers are operatively coupled to one or more electronic scoring systems affiliated with the one or more activity centers, wherein one or more users physically perform one or more activities at the one or more activity centers, a method for enabling virtual activity challenges, comprising the steps of:
receiving a request from a user at the VAMS management server relating to initiation of an electronic activity challenge corresponding to a physical activity being performed by the user at a particular activity center, wherein the request is transmitted to the VAMS management computer system by an electronic device of the user;
retrieving one or more predefined rules that define criteria of the electronic activity challenge initiated by the user;
receiving and storing activity information at the VAMS management server corresponding to the physical activity being performed by the user at the particular activity center, wherein the activity information is necessitated by the criteria of the one or more predefined rules relating to the electronic activity challenge, and wherein the activity information is obtained from a particular electronic scoring system at the particular activity center and transmitted to the VAMS management server via a particular edge server at the particular activity center; and
upon determination that the activity information satisfies the criteria of the electronic activity challenge, generating an outcome of the electronic activity challenge.

2. The method of claim 1, wherein the particular edge server comprises a plug PC.

3. The method of claim 1, wherein the electronic activity challenge comprises one or more of the following: head-to-head virtual game play, virtual game play, user-defined game play, an in-activity challenge, a subset of the physical activity.

4. The method of claim 1, wherein the physical activity being performed by the user comprises a sporting event.

5. The method of claim 4, wherein the sporting event being performed by the user is selected from the group comprising: bowling, golf, fishing, running, cross-training.

6. The method of claim 1, wherein the electronic device of the user is selected from the group comprising: a cellular phone, a smart phone, a tablet computer, a laptop computer, a personal digital assistant (PDA).

7. The method of claim 1, further comprising the steps of:
identifying a second user to compete in the electronic activity challenge;
retrieving activity information corresponding to a physical activity being performed by the second user; and
using the activity information corresponding to the physical activity being performed by the second user in connection with generating the outcome of the electronic activity challenge.

8. The method of claim 7, wherein the second user is performing the physical activity at a second activity center geographically disparate from the particular activity center.

9. The method of claim 1, wherein the particular edge server at the particular activity center is in electronic communication with the particular electronic scoring system managed by the particular activity center.

10. The method of claim 1, wherein the outcome of the electronic activity challenge is selected from the group comprising: win, lose, draw, true, false, error.

11. The method of claim 1, further comprising the step of transmitting the generated outcome from the VAMS management server to the electronic device of the user.

12. The method of claim 1, further comprising the step of displaying the outcome of the electronic activity challenge to the user via the electronic device of the user.

13. A method for managing activity data corresponding to physical activities being performed by players at one or more activity centers, wherein one or more local edge servers are physically located at the one or more activity centers and are in operative communication with one or more electronic scoring systems at the one or more activity centers, comprising the steps of:
receiving activity data at a particular local edge server from a respective electronic scoring system at a particular activity center, the activity data corresponding to an activity being performed by a player at the particular activity center;
comparing the activity data to a predetermined data template that defines individual data elements expected in the activity data;
identifying particular data elements of the activity data that satisfy the individual data elements in the predetermined data template:
generating normalized activity data that satisfies a predetermined format based on the identified particular data elements of the activity data; and
transmitting the normalized activity data from the particular local edge server to a management computer system for subsequent use in connection with virtual activity challenges of the player.

14. The method of claim 13, wherein the particular local edge server comprises a plug PC.

15. The method of claim 13, wherein the activity being performed by the player comprises a sporting event.

16. The method of claim 15, wherein the sporting event being performed by the user is selected from the group comprising: bowling, golf, fishing, running, cross-training.

17. The method of claim 13, wherein the normalized activity data is used by the management computer system to conduct virtual activity challenges for players.
